(19) United States
(12) Patent Application Publication
(10) Pub. No.: US 2026/0322694 A1
(43) Pub. Date: Oct. 15, 2026

(54) INTERNET OF THINGS DEVICE-BASED INTERWORKING METHOD FOR SERVICE COLLABORATION AND DEVICES FOR PERFORMING THE SAME

(71) Applicant: Electronics and Telecommunications Research Institute, Daejeon (KR)

(72) Inventor: Younghwan CHOI, Daejeon (KR)

(73) Assignee: Electronics and Telecommunications Research Institute, Daejeon (KR)

(21) Appl. No.: 19/644,291

(22) Filed: Apr. 10, 2026

(30) Foreign Application Priority Data
Apr. 11, 2025 (KR) 10-2025-0047130
Mar. 27, 2026 (KR) 10-2026-0055716

(51) Int. Cl. H04L 41/0894; H04W 8/20; H04W 60/00

(52) U.S. Cl. CPC H04L 41/0894; H04W 8/20; H04W 60/00

(57) ABSTRACT

An Internet of Things (IoT) device-based interworking method for service collaboration and devices for performing the method are provided. A method for service interworking includes receiving a profile forwarding message including a device profile of a terminal device, based on the device profile, evaluating service interworking potential for the terminal device to generate a policy generation request message for generating policy information, and in response to the policy generation request message, generating the policy information using the device profile.

### CROSS-REFERENCE TO RELATED APPLICATION

This application claims the benefit of Korean Patent Application No. 10-2025-0047130, filed on Apr. 11, 2025, and Korean Patent Application No. 10-2026-0055716, filed on Mar. 27, 2026, in the Korean Intellectual Property Office (now the Ministry of Intellectual Property (MOIP)), the entire disclosure of which is incorporated herein by reference for all purposes.

### BACKGROUND

### 1. Field of the Invention

One or more embodiments relate to an Internet of Things (IoT) device-based interworking method for service collaboration and devices for performing the same.

### 2. Description of the Related Art

IoT has become essential fundamental technology in information & communication technology (ICT) convergence services. IoT is the technology for connecting devices and objects over a network to enable data sharing and automation. With artificial intelligence (AI), the need for AI-based IoT technology is increasingly emerging.

IoT is evolving beyond intelligent IoT toward autonomous IoT. IoT hyper-connectivity includes both connections among local devices within the same network domain and connections with remote devices on the Internet (e.g., cloud).

The above description has been possessed or acquired by the inventor(s) in the course of conceiving the present disclosure and is not necessarily an art publicly known before the present application is filed.

### SUMMARY

Embodiments provide essential additional technology for intelligent Internet of Things (IoT) service collaboration and corresponding devices and method.

Embodiments provide three additional essential technical elements for intelligent device discovery, including (1) a method of segmenting a profile for intelligent discovery, (2) a profile management and registration method, and (3) an identification method and an identification procedure for efficient discovery.

However, the technical goals are not limited to the foregoing goals, and there may be other technical goals.

According to an aspect, there is provided a method for service interworking, the method including receiving a profile forwarding message including a device profile of a terminal device, based on the device profile, evaluating service interworking potential for the terminal device to generate a policy generation request message for generating policy information, and in response to the policy generation request message, generating the policy information using the device profile.

The policy information may include one or more of data related to a terminal device policy and data related to a service policy.

The method may further include registering a record including the policy information together with a device identifier (ID) of the terminal device, the device profile, and a profile ID of the device profile.

The policy information may be used to extract, from a plurality of candidate terminal devices, a target terminal device having functionality required for interworking between the terminal device and a service.

The method may further include transmitting the policy information to a terminal management device configured to manage the terminal device.

The terminal management device may be configured to apply the policy information to the terminal device.

The method may further include receiving a request for discovering a target terminal device having functionality required for interworking between the terminal device and a service.

The request for discovering the target terminal device may include the device profile of the terminal device.

The method may further include extracting a suitable target device profile from candidate device profiles, based on the policy information of the terminal device.

According to another aspect, there is provided a device for service interworking, the device including a processor and memory electrically connected to the processor and storing instructions executable by the processor, wherein the instructions, when executed by the processor, may cause the device to perform a plurality of operations, and wherein the plurality of operations may include receiving a profile forwarding message including a device profile of a terminal device, based on the device profile, evaluating service interworking potential for the terminal device to generate a policy generation request message for generating policy information, and in response to the policy generation request message, generating the policy information using the device profile.

The policy information may include one or more of data related to a terminal device policy and data related to a service policy.

The plurality of operations may further include registering a record including the policy information together with a device ID of the terminal device, the device profile, and a profile ID of the device profile.

The policy information may be used to extract, from a plurality of candidate terminal devices, a target terminal device having functionality required for interworking between the terminal device and a service.

The plurality of operations may further include transmitting the policy information to a terminal management device configured to manage the terminal device.

The terminal management device may be configured to apply the policy information to the terminal device.

The plurality of operations may further include receiving a request for discovering a target terminal device having functionality required for interworking between the terminal device and a service.

The request for discovering the target terminal device may include the device profile of the terminal device.

The plurality of operations may further include extracting a suitable target device profile from candidate device profiles, based on the policy information of the terminal device.

Additional aspects of embodiments will be set forth in part in the description which follows and, in part, will be apparent from the description, or may be learned by practice of the disclosure.

An embodiment may provide a framework for organically linking an IoT device with cloud and an edge computing environment, thereby enabling integrated management of the entire lifecycle from data collection to analysis and control. Accordingly, it may be possible to establish a consistent data flow and control mechanism even in a complex IoT service environment.

An embodiment may enable service pattern analysis of an IoT device and autonomous policy generation based on the convergence of advanced technologies such as artificial intelligence (AI), distributed ledger technology (DLT), and big data processing. Accordingly, beyond simple command execution, a device may learn and apply an optimized control policy on its own, enhancing the intelligence and autonomy of a service.

An embodiment may perform a context awareness-based connection based on profile information of a registered device and may automatically optimize inter-device connectivity through real-time, policy-based matching. This enables the configuration of collaborative services among devices without user intervention.

An embodiment may ensure the integrity, consistency, and reliability of an IoT device and service data through a DLT-based storage approach, while simultaneously securing transparency and security in data sharing and interworking.

Unlike conventional fragmented IoT connectivity technologies or single-platform-based analytics solutions, an embodiment may provide a comprehensive framework that intelligently connects, analyzes, and controls the entire IoT ecosystem, thereby enabling highly scalable and advanced services applicable to various domains such as a smart city, a smart home, and industrial automation.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating devices for Internet of Things (IoT) according to an embodiment;

FIG. 2 is a diagram illustrating device registration according to an embodiment;

FIG. 3 is a diagram illustrating a procedure for sharing device registration information according to an embodiment;

FIG. 4 is a diagram illustrating an analysis procedure for generating an intelligent service policy using a device profile, according to an embodiment;

FIG. 5 is a diagram illustrating an operation of discovering a device profile according to an embodiment;

FIG. 6 is a diagram illustrating a connection between devices according to an embodiment; and

FIG. 7 is a schematic block diagram of a device according to an embodiment.

### DETAILED DESCRIPTION

The following structural or functional descriptions of embodiments are provided as examples only, and various alterations and modifications may be made to the embodiments. Accordingly, the embodiments are not construed as limited to the disclosure and should be understood to include all changes, equivalents, and replacements within the idea and the technical scope of the disclosure.

Although terms of "first," "second," and the like are used to explain various components, the components are not limited to such terms. These terms are used only to distinguish one component from another component. For example, a first component may be referred to as a second component, or similarly, the second component may be referred to as the first component.

It should be noted that if it is described that one component is "connected," "coupled," or "joined" to another component, a third component may be "connected," "coupled," and "joined" between the first and second components, although the first component may be directly connected, coupled, or joined to the second component.

As used herein, the singular forms "a," "an," and "the" are intended to include the plural forms as well, unless the context clearly indicates otherwise. As used herein, "A or B," "at least one of A and B," "at least one of A or B," "A, B or C," "at least one of A, B and C," and "at least one of A, B, or C," each of which may include any one of the items listed together in the corresponding one of the phrases, or all possible combinations thereof. It will be understood that the terms "comprises/comprising" and/or "includes/including" when used herein, specify the presence of stated features, integers, steps, operations, elements, components, or groups thereof, but do not preclude the presence or addition of one or more other features, integers, steps, operations, elements, components, or groups thereof.

Unless otherwise defined, all terms, including technical and scientific terms, used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

As used in connection with the present disclosure, the term "module" may include a unit implemented in hardware, software, or firmware, and may interchangeably be used with other terms, for example, "logic," "logic block," "part," or "circuitry." A module may be a single integral component, or a minimum unit or part thereof, adapted to perform one or more of functions. For example, according to an embodiment, the module may be implemented in a form of an application-specific integrated circuit (ASIC).

The term "unit" or the like used herein may refer to a software or hardware component, such as a field-programmable gate array (FPGA) or an ASIC, and the "unit" performs predefined functions. However, the term "unit" is not limited to software or hardware. A "unit" may be configured to be in an addressable storage medium or configured to operate one or more processors. Accordingly, the "unit" may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and "units" may be combined into fewer components and "units" or may be further separated into additional components and "units." Furthermore, the components and "units" may be implemented to operate on one or more central processing units (CPUs) within a device or a security multimedia card. In addition, "unit" may include one or more processors.

Hereinafter, embodiments will be described in detail with reference to the accompanying drawings. When describing the embodiments with reference to the accompanying drawings, like reference numerals refer to like components and a repeated description related thereto will be omitted.

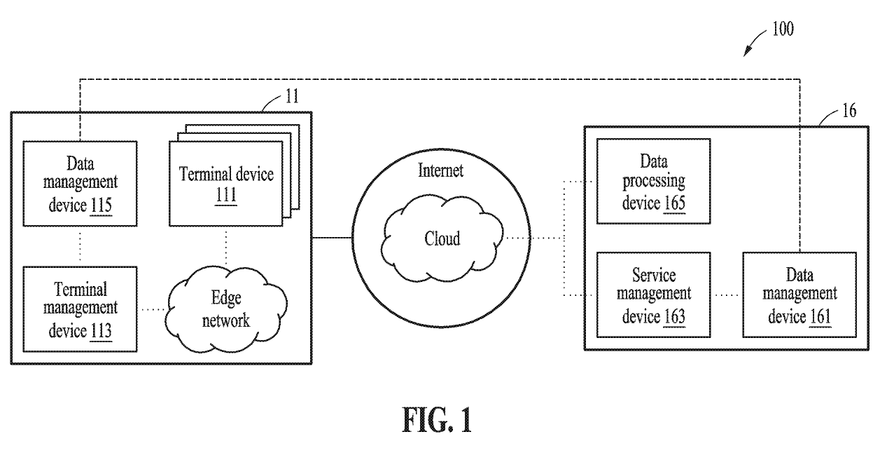

FIG. 1 is a diagram illustrating devices for Internet of Things (IoT) according to an embodiment.

Referring to FIG. 1, according to an embodiment, a framework 100 for an IoT service may include one or more edge network-based device groups (e.g., an edge network-based device group 11) and a cloud-based device group 16. There may be two or more edge network-based device groups, and hereinafter, for ease of description, the framework 100 including a single edge network-based device group (i.e., the edge network-based device group 11) is described as an example.

The edge network-based device group 11 may include a terminal device 111, a terminal management device 113 (e.g., a terminal management server), and a data management device 115 (e.g., a data management server). The edge network-based device group 11 may be based on an edge network. The components (e.g., the terminal device 111, the terminal management device 113, and the data management device 115) in the edge network-based device group 11 may be connected to one another via the edge network.

The terminal device 111 may include all types of IoT devices (e.g., a sensor and an actuator) used for an IoT service. The terminal device 111 may be a terminal device that provides direct functionality to a service client.

The terminal device 111 may provide data management functionality. The terminal device 111 may collect data related to an IoT service requirement. The terminal device 111 may receive a user input or collect environmental information. For example, the terminal device 111 may obtain user-related information (or user-related data) (e.g., temperature, humidity, illuminance, fine dust, or energy consumption) related a surrounding environment of a user and a lifestyle pattern of the user. The terminal device 111 may obtain the user-related information in real time and/or at predetermined time intervals. The terminal device 111 may transmit the user-related information to the terminal management device 113.

The terminal device 111 may provide service action information management functionality. The terminal device 111 may perform an operation. For example, the terminal device 111 may manage service action information (e.g., switch control, sound information, or video information) necessary to provide an IoT service to the user and may perform the service action information. The terminal device 111 may obtain, store, retrieve, and/or update the service action information in real time and/or at predetermined time intervals.

The terminal device 111 may provide context awareness-based service management functionality. The terminal device 111 may receive control information (or control data) from the terminal management device 1111 and may provide the user with an IoT service based on the control information. For example, the terminal device 111 may generate the service action information of the terminal device 111 based on the control information and may operate based on the service action information. The control information may include information for updating information (e.g., service action information) of the terminal device 111 and controlling the action state of the terminal device 111. The terminal device 111 may transmit, to the terminal management device 113, data related to the current service action information of the terminal device 111.

The terminal device 111 may provide edge server management functionality. The terminal device 111 may retrieve, register, and/or update information (e.g., a terminal management device identifier (ID)) of the terminal management device 113 that may be connected to the terminal device 111.

The terminal management device 113 may operate as a gateway for the terminal device 111 on the edge network.

The terminal management device 113 may provide terminal device connectivity management functionality. The terminal management device 113 may be responsible for connecting, registering, and controlling the terminal device 111. For example, the terminal management device 111 may retrieve, register, and/or update terminal device information (e.g., a device ID or service action information (or action state)) of the terminal device 111. Service action information may be included in a device profile. The terminal device 111 may have functions that may be utilized for a service. Function information regarding functions included in the terminal device 111 may be referred to as a device profile.

The terminal management device 113 may provide service information management functionality. The terminal management device 113 may retrieve, register, and/or update service-related information (or service-related data) for an IoT service desired by the user. For example, in response to receiving an IoT service request from the user, the terminal management device 113 may retrieve, register, and/or update service-related information such as a service ID, a service requirement, and/or a connected apparatus ID (e.g., a connected device ID).

The terminal management device 113 may provide data management functionality. The terminal management device 113 may obtain and/or store terminal device information, service-related information, and/or user-related information.

The terminal management device 113 may provide context awareness-based control management functionality. The terminal management device 113 may receive control information from a service management device 163 included in the cloud-based device group 16 and may transmit the control information to the terminal device 111.

The terminal management device 113 may provide terminal device performance management functionality. The terminal management device 113 may maintain the performance of the terminal device 111 by controlling the load of a storage device (e.g., the data management device 115) and/or the traffic of a network (e.g., the edge network).

The terminal management device 113 may provide the context awareness-based data processing functionality. The terminal management device 113 may process user-related information. For example, the terminal management device 113 may perform pre-processing such as filtering, buffering, and/or generating cumulative data. The terminal management device 113 may store pre-processed user-related information in the data management device 115.

The terminal management device 113 may provide user management functionality. The terminal management device 113 may retrieve, register, and/or update user information (e.g., a user ID or authentication information). The terminal management device 113 may enhance service security through user management functionality.

The data management device 115 may be connected to the terminal management device 113. The data management device 115 may store data and use a blockchain to share the stored data with a data management device in another edge network-based device group and/or a data management device 161 in the cloud-based device group 16.

The data management device 115 may provide terminal device information management functionality. The data management device 115 may store terminal device information (e.g., a device ID or service action information (or action state) of the terminal device) of the terminal device 111. The data management device 115 may provide the user with functionality to retrieve the stored terminal device information.

The data management device 115 may provide service information management functionality. The data management device 115 may store service-related information (or service-related data) for an IoT service desired by the user. The data management device 115 may provide the user with functionality for retrieving service-related information.

Using a blockchain, the data management device 115 may share data sharing functionality (e.g., stored data (e.g., terminal device information, user-related information, or service-related information)) with a data management device within another edge network-based device group and/or the data management device 161 in the cloud-based device group 16.

The cloud-based device group 16 may include the data management device 161, the service management device 163, and a data processing device 165. The data management device 161, the service management device 163, and the data processing device 165 may be implemented as separate devices or as a single device. The cloud-based device group 16 may be based on an internet network (e.g., cloud). The components (e.g., the data management device 161, the service management device 163, and the data processing device 165) in the cloud-based device group 16 may be connected to one another via the internet network (e.g., cloud).

The service management device 163 may be linked with the terminal management device 113 and a data management device (e.g., the data management device 115 or the data management device 161) to manage terminal device information, user-related information, and service-related information. The service management device 163 may receive data (e.g., terminal device information, user-related information, and service-related information) from the data management device 161 and may select data to be used for reinforcement learning from the received data. The service management device 163 may transmit the selected data to the data processing device 165.

The service management device 163 may provide terminal device policy management functionality. The service management device 163 may generate, modify, and store information regarding a terminal device policy. Based on the user-related data, the service management device 163 may generate data related to service action information of the terminal device 111 in the edge network-based device group 11. For example, the service management device 163 may modify data on a possibility of change in service action information of the terminal device 111 based on an amount of change in the user-related data. Based on the user-related data, the service management device 163 may manage data (e.g., a terminal device policy, a terminal device policy ID, or a device ID) related to the terminal device policy.

The service management device 163 may provide service policy management functionality. The service management device 163 may generate, modify, and store information regarding a service policy. The service management device 163 may modify service-related data (e.g., a service requirement or a connected device ID) based on the user-related data. Based on the user-related data, the service management device 163 may manage data (e.g., a service policy, a service policy ID, or a device ID) related to a service policy.

The service management device 163 may provide learning data management functionality. The service management device 163 may generate learning data based on data on the possibility of change in the service action information of the terminal device 111. The service management device 163 may transmit training data to the data processing device 165. Based on the training data, the service management device 163 may generate and/or modify data (e.g., a terminal device policy, a terminal device policy ID, or a device ID) related to a terminal device policy and/or data (e.g., a service policy or a service policy ID) related to a service policy.

The service management device 163 may provide context awareness-based control management functionality. The service management device 163 may transmit the data related to a terminal device policy and the data related to a service policy to the terminal management device 115 in the edge network-based device group 11.

The service management device 163 may provide data management functionality. The service management device 163 may perform data operations such as data collection, data pre-processing, data analysis, data transfer, data storage, data synchronization, data query, data security, and data visualization for an IoT service.

The data processing device 165 may receive data (e.g., training data) from the service management device 163 and generate control information (or control data) of the terminal device 111 in the edge network-based device group 11 using the received data. The data processing device 165 may generate control information based on reinforcement learning. For example, the data processing device 165 may predict a change in service action information of the terminal device 111 based on collective intelligence and/or collaborative intelligence.

The data management device 165 may store the control information and share the control information with the data management device 115 in the edge network-based device group 11. Functionality provided by the data management device 165 may be substantially the same as functionality provided by the data management device 115 in the edge network-based device group 11. Accordingly, a repeated description thereof is omitted.

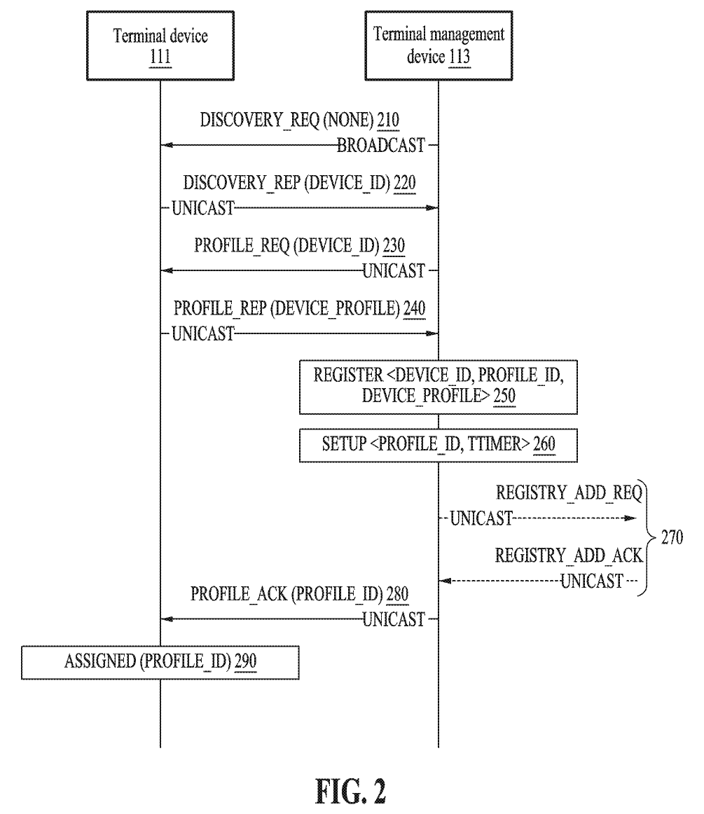

FIG. 2 is a diagram illustrating device registration according to an embodiment.

In FIG. 2, a device registration procedure may include device registration and profile cloud registration. FIG. 2 may show a registration operation between the terminal device 111 and the terminal management device 113 in the same edge network.

In operation 210, the terminal management device 113 may broadcast a discovery request message (DISCOVERY_REQ(NONE)) to discover a local device (e.g., an unknown local device) in the same edge network (e.g., the same subnet).

In operation 220, the terminal device 111 that receives the discovery request message (DISCOVERY_REQ(NONE)) may reply to the terminal management device 113 with a discovery response message (DISCOVERY_REP(DEVICE_ID)) (e.g., a unicast message) including the device ID of the terminal device 111.

In operation 230, the terminal management device 113 may transmit a profile request message (PROFILE_REQ(DEVICE_ID)) (e.g., a unicast message) requesting a device profile to the terminal device 111, which is a registered (or newly registered) terminal device.

In operation 240, the terminal device 111 may respond to the profile request message (PROFILE_REQ(DEVICE_ID)) and transmit a profile response message (PROFILE_REP(DEVICE_ PROFILE) including the device profile to the terminal management device 113.

In operation 250, the terminal management device 113 may generate a first profile ID (e.g., a tentative profile ID) for the device profile based on the device profile and may register a record (e.g., a record corresponding to the terminal device 111) including the device ID, the device profile, and the first profile ID in a local registry (e.g., a database) in the terminal management device 113.

In operation 260, the terminal management device 113 may set a timer with a predefined set duration for the record.

In operation 270, the terminal management device 113 may initiate a registration operation (e.g., REGISTRY_ADD_REQ, REGISTRY_ADD_ACK) for a cloud network of the device profile. When the registration operation for the cloud network is terminated, the ID of the device profile may be determined as a second profile ID (e.g., a regular profile ID) for the terminal device 111, and the terminal management device 113 may finally register (e.g., update) the second profile ID in the local registry (e.g., the database).

In operation 280, the terminal management device 113 may transmit a profile confirmation message (PROFILE_ACK(PROFILE_ID)) including the second profile ID to the terminal device 111.

In operation 290, the terminal device 111 may receive and store the second profile ID assigned to the device profile of the terminal device 111.

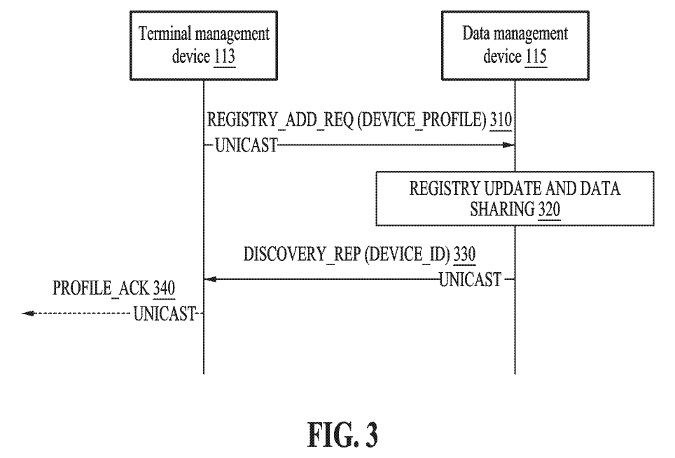

FIG. 3 is a diagram illustrating a procedure for sharing device registration information according to an embodiment.

In operation 310, the terminal management device 113 may transmit, to the data management device 115, a registry add request message (REGISTRY_ADD_REQ(DEVICE_PROFILE)) (e.g., a unicast message) requesting storage of a device profile of the terminal device 111, which is a registered (or newly registered) terminal device.

In operation 320, the data management device 115 may store the device profile of the terminal device 111 and may share the device profile of the terminal device 111 with an external device (e.g., the data management device 161 or the service management device 163) on an external network.

In operation 330, the data management device 115 may reply to the terminal management device 113 with a profile add response message (PROFILE_ADD_REQ(DEVICE_ID)) (e.g., a unicast message).

In operation 340, the device profile of the terminal device 111 may be registered on the external network (e.g., cloud), and the terminal management device 113 may notify the terminal device 111 of corresponding information to terminate the registration procedure.

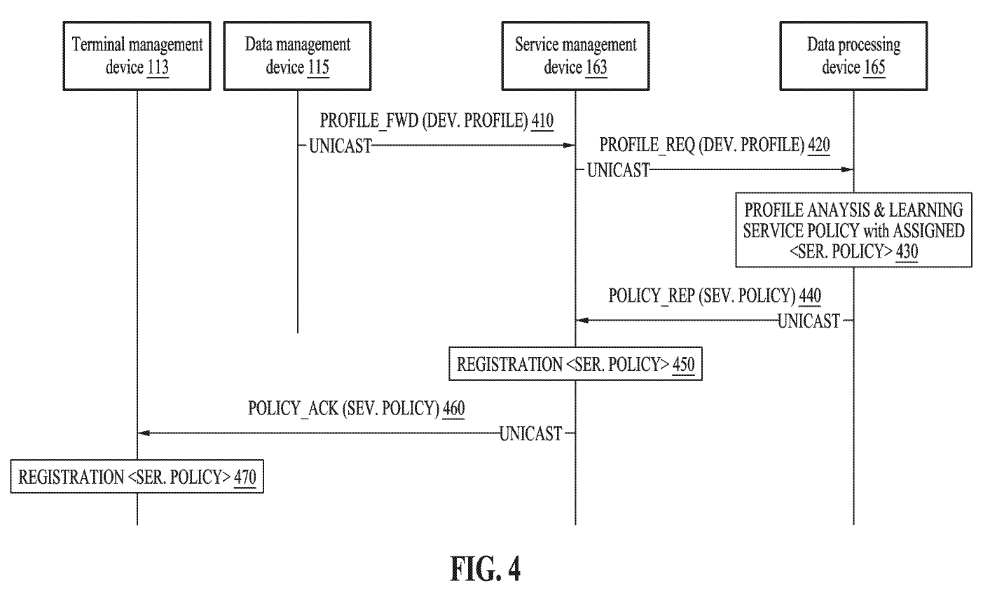

FIG. 4 is a diagram illustrating an analysis procedure for generating an intelligent service policy using a device profile, according to an embodiment.

In operation 410, the data management device 115 may transmit a profile forwarding message (PROFILE_FWD(DEVICE_PROFILE)) (e.g., a unicast message) including a device profile of the terminal device 111 to the service management device 163.

In operation 420, the service management device 163 may evaluate the potential for service interworking based on the device profile included in the profile forwarding message (PROFILE_FWD(DEVICE_PROFILE)) and then transmit a policy generation request message (POLICY_REQ(DEVICE_PROFILE)) (e.g., a unicast message) to the data processing device 165 to generate a policy (e.g., policy information). A policy request message (POLICY_REQ(DEVICE_PROFILE)) may include a device profile.

In operation 430, the data processing device 165 may generate policy information (SER.POLICY) based on the device profile. For example, the data processing device 165 may perform machine learning or inference-based analysis using the device profile and generate the policy information (SER.POLICY). The policy information (SER.POLICY) may include data related to a terminal device policy and/or data related to a service policy.

In operation 440, the data processing device 165 may transmit a policy response message (POLICY_REP(SER.POLICY)) (e.g., a unicast message) including the policy information (SER.POLICY) to the service management device 163.

In operation 450, the service management device 163 may register the policy information (SER.POLICY). For example, the service management device 163 may register and store a record (e.g., a record corresponding to the terminal device 111) including the policy information (SER.POLICY) along with a device ID, a device profile, and a profile ID.

In operation 460, the service management device 163 may transmit a policy response message (POLICY_ACK(SER.POLICY)) (e.g., a unicast message) including the policy information (SER.POLICY) to the terminal management device 113.

In operation 470, the terminal management device 113 may register the policy information (SER.POLICY). For example, the service management device 163 may register and store a record (e.g., a record corresponding to the terminal device 111) including the policy information (SER.POLICY) along with a device ID, a device profile, and a profile ID. The terminal management device 113 may apply the policy information (SER.POLICY) to the terminal device 111. The terminal device 111 may receive a context-based intelligent policy (e.g., policy information (SER.POLICY)) and may perform an autonomous and optimized service in real time according to the intelligent policy (e.g., policy information (SER.POLICY)).

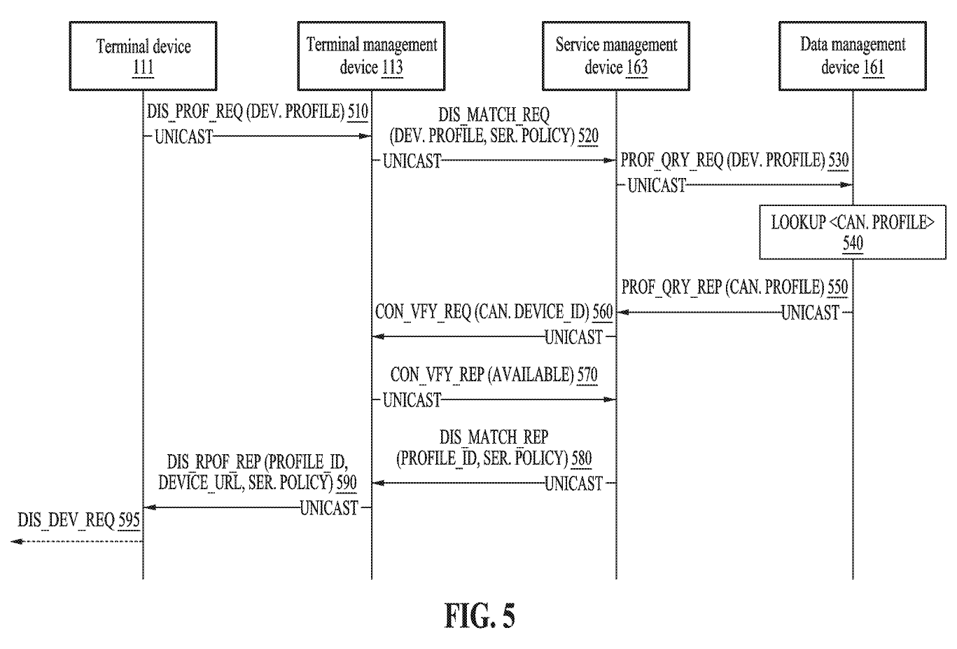

FIG. 5 is a diagram illustrating an operation of discovering a device profile according to an embodiment.

FIG. 5 may illustrate an operation of searching for a device profile of a target terminal device that may interwork through the service management device 163 existing on a cloud network.

In operation 510, the terminal device 111 may transmit a discovery profile request message (DIS_PROF_REQ(DEVICE_PROFILE)) (e.g., a unicast message) to the terminal management device 113 to discover the device profile of the target terminal device that has a necessary function for service interworking (e.g., collaboration). The discovery profile request message (DIS_PROF_REQ(DEVICE_PROFILE)) may include the device profile of the terminal device 111 requesting service interworking (e.g., collaboration).

In operation 520, the terminal management device 113 may generate a discovery matching request message (DIS_MATCH_REQ(DEVICE_PROFILE, SER.POLICY)) (e.g., a unicast message) based on the service policy of the terminal device 111 and may transmit the discovery matching request message (DIS_MATCH_REQ(DEVICE_PROFILE, SER.POLICY)) to the service management device 163. The discovery matching request message (DIS_MATCH_REQ(DEVICE_PROFILE, SER.POLICY)) may include the device profile of the terminal device 111 and a policy (e.g., policy information (SER.POLICY)) of the terminal device 111.

In operation 530, the service management device 163 may transmit a profile query request message (PROF_QRY_REQ(DEVICE_PROFILE)) (e.g., a unicast message) to the data management device 161 to discover a candidate device profile to be used for service interworking. The profile query request message (PROF_QRY_REQ(DEVICE_PROFILE)) may include the device profile of the terminal device 111 requesting service interworking (e.g., collaboration).

In operation 540, the data management device 161 may find candidate device profiles to be used for service interworking based on the device profile of the terminal device 111.

In operation 550, the data management device 161 may transmit, to the service management device 163, a profile query response message (PROF_QRY_REP(CAN.PROFILE)) (e.g., a unicast message) including the candidate device profiles to be used for service interworking.

In operation 560, the service management device 163 may transmit a connection confirmation request message (CON_VFY_REQ(CAN.DEVICE_ID)) (e.g., a unicast message) to the terminal management device 113 to inquire whether the terminal device 111 of the target terminal device corresponding to the target device profile is connectable. For example, the service management device 163 may extract a suitable target device profile from the candidate device profiles based on the service policy (e.g., policy information (SER.POLICY)) of the terminal device 111 and may generate a connection confirmation request message (CON_VFY_REQ(CAN.DEVICE_ID)) including a device ID of a target device corresponding to the target device profile.

In operation 570, the terminal management device 113 may transmit a connection confirmation response message (CON_VFY_REP(AVAILALE)) including a confirmation result to the service management device 163.

In operation 580, the service management device 163 may identify a confirmation result included in the connection confirmation response message (CON_VFY_REP(AVAILALE)) and may transmit, to the terminal management device 113, the discovery matching response message (DIS_MATCH_REP(DEVICE_ID, SER.POLICY)) (e.g., a unicast message) including the device ID of the target device and the policy information (SER.POLICY) of the target device.

In operation 590, the terminal management device 113 may find connection information (e.g., uniform resource locator (URL) and/or session information) for the target device based on the device ID of the target device and may transmit, to the terminal device 111, the discovery profile response message (DIS_PROF_REP(DEVICE_ID, DEVICE_PROFILE, SER.POLICY)) (e.g., the unicast message) including the device ID of the target device, the policy information (SER.POLICY) of the target device, and the connection information (e.g., URL and/or session information) of the target device.

In operation 595, the terminal device 111 may transmit a discovery device request message (DIS_DEV_REQ(PROFILE_ID)) (e.g., a unicast message) to the target device to request additional information. The discovery device request message (DIS_DEV_REQ(PROFILE_ID)) may include a profile ID of the device profile of the terminal device 111.

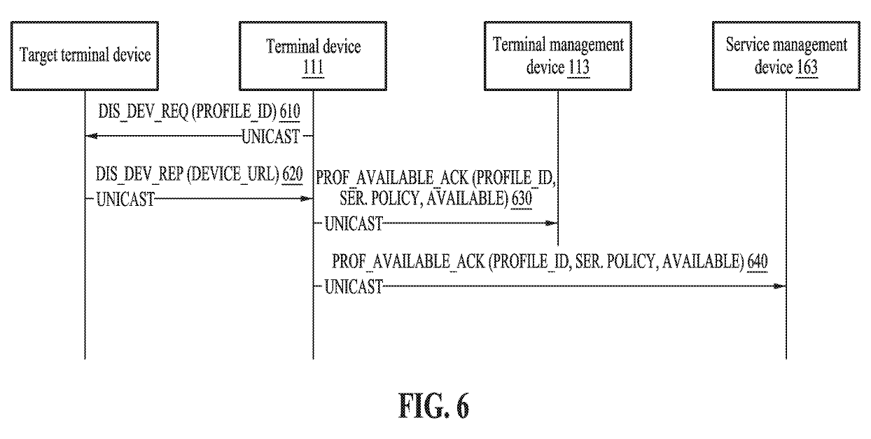

FIG. 6 is a diagram illustrating a connection between devices according to an embodiment.

FIG. 6 may relate to a procedure for registering a connection state when two devices have a new connection for service interworking.

In operation 610, the terminal device 111 may perform a direct connection request by transmitting a DIS_DEV_REQ(PROFILE_ID) message to a target terminal device through the URL of the target terminal device.

In operation 620, the target terminal device may respond to the terminal device 111 with a DIS_DEV_REP(DEVICE_URL) message to indicate that the target terminal device is ready to be connected.

In operations 630 and 640, the terminal device 111 may report whether the connection is successful to the terminal management device 113 and the service management device 163 via a PROF_AVAILABLE_ACK(PROFILE_ID, SER.POLICY, AVAILABLE) message.

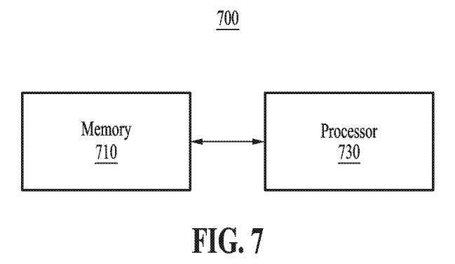

FIG. 7 is a schematic block diagram of a device according to an embodiment.

Referring to FIG. 7, according to an embodiment, a device 700 (e.g., the terminal device 111, the terminal management device 113, the data management device 115, the data management device 161, the service management device 163, or the data processing device 165 of FIG. 1) may include memory 720 and a processor 740.

The memory 740 may store instructions (or a program) executable by the processor 720. For example, the instructions may include instructions for executing operations of the processor 720 and/or operations of each component of the processor 720.

The memory 740 may include one or more computer-readable storage media. The memory 740 may include non-volatile storage elements (e.g., a magnetic hard disc, an optical disc, a floppy disc, flash memory, erasable programmable read-only memory (EPROM), and electrically erasable programmable ROM (EEPROM)).

The memory 740 may be non-transitory media. The term "non-transitory" may indicate that a storage medium is not implemented as a carrier wave or propagated signal. However, the term "non-transitory" should not be interpreted to indicate that the memory 740 is non-movable.

The processor 720 may process data stored in the memory 740. The processor 720 may execute computer-readable code (e.g., software) stored in the memory 740 and instructions triggered by the processor 720.

The processor 720 may be a data processing device implemented as hardware having a circuit having a physical structure for executing desired operations. For example, the desired operations may include code or instructions included in a program.

For example, the data processing device implemented as hardware may include a microprocessor, a CPU, a processor core, a multi-core processor, a multiprocessor, an ASIC, or an FPGA.

Operations performed by the processor 720 may be substantially the same as the operations of the terminal device 111, the terminal management device 113, the data management device 115, the data management device 161, the service management device 163, or the data processing device 165 of FIG. 1 described with reference to FIGS. 1 to 6. Accordingly, a detailed description thereof is omitted.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using hardware components, software components, and/or a combination thereof. For example, the device, the method, and the components described in the embodiments may be implemented using a general-purpose or special-purpose computer, such as a processor, a controller, an arithmetic logic unit (ALU), a digital signal processor (DSP), a microcomputer, an FPGA, a programmable logic unit (PLU), a microprocessor, or any other devices capable of responding to and executing instructions. The processing device may run an operating system (OS) a software application that runs on the OS. The processing device may also access, store, manipulate, process, and generate data in response to execution of software. For purpose of simplicity, the description of a processing device is used as singular; however, one skilled in the art will appreciate that a processing device may include a plurality of processing elements and/or a plurality of types of processing elements. For example, the processing device may include a plurality of processors or a single processor and a single controller. In addition, different processing configurations are possible, such as parallel processors.

Software may include a computer program, a piece of code, an instruction, or one or more combinations thereof, to independently or collectively instruct or configure a processing device to operate as desired. Software and/or data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in non-transitory computer-readable storage media.

The method according to the embodiments described above may be recorded in the non-transitory computer-readable storage media including program instructions to implement various operations of the embodiments described above. The non-transitory computer-readable storage media may also store, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable storage media include magnetic media such as hard disks, floppy disks, and magnetic tape; optical media such as compact disc ROM (CD-ROM) discs and digital video discs (DVDs); magneto-optical media such as floptical disks; and hardware devices that are specifically configured to store and perform program instructions, such as ROM, random-access memory (RAM), flash memory, and the like. Examples of program instructions include both machine code, such as code produced by a compiler, and files containing higher-level code that may be executed by the computer using an interpreter.

The hardware devices described above may be configured to act as one or more software modules in order to perform the operations of the embodiments described above, or vice versa.

As described above, although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. A method for service interworking, the method comprising:
receiving a profile forwarding message comprising a device profile of a terminal device;
based on the device profile, evaluating service interworking potential for the terminal device to generate a policy generation request message for generating policy information; and
in response to the policy generation request message, generating the policy information using the device profile.

2. The method of claim 1, wherein the policy information comprises one or more of data related to a terminal device policy and data related to a service policy.

3. The method of claim 1, further comprising:
registering a record comprising the policy information together with a device identifier (ID) of the terminal device, the device profile, and a profile ID of the device profile.

4. The method of claim 1, wherein the policy information is used to extract, from a plurality of candidate terminal devices, a target terminal device having functionality required for interworking between the terminal device and a service.

5. The method of claim 1, further comprising:
transmitting the policy information to a terminal management device configured to manage the terminal device.

6. The method of claim 5, wherein the terminal management device is configured to apply the policy information to the terminal device.

7. The method of claim 1, further comprising:
receiving a request for discovering a target terminal device having functionality required for interworking between the terminal device and a service.

8. The method of claim 7, wherein the request for discovering the target terminal device comprises the device profile of the terminal device.

9. The method of claim 7, further comprising:
extracting a suitable target device profile from candidate device profiles, based on the policy information of the terminal device.

10. A device for service interworking, the device comprising:
a processor; and
memory electrically connected to the processor and storing instructions executable by the processor,
wherein the instructions, when executed by the processor, cause the device to perform a plurality of operations, and
wherein the plurality of operations comprises:
receiving a profile forwarding message comprising a device profile of a terminal device;
based on the device profile, evaluating service interworking potential for the terminal device to generate a policy generation request message for generating policy information; and
in response to the policy generation request message, generating the policy information using the device profile.

11. The device of claim 10, wherein the policy information comprises one or more of data related to a terminal device policy and data related to a service policy.

12. The device of claim 10, wherein the plurality of operations further comprises:
registering a record comprising the policy information together with a device identifier (ID) of the terminal device, the device profile, and a profile ID of the device profile.

13. The device of claim 10, wherein the policy information is used to extract, from a plurality of candidate terminal devices, a target terminal device having functionality required for interworking between the terminal device and a service.

14. The device of claim 10, wherein the plurality of operations further comprises:
transmitting the policy information to a terminal management device configured to manage the terminal device.

15. The device of claim 14, wherein the terminal management device is configured to apply the policy information to the terminal device.

16. The device of claim 10, wherein the plurality of operations further comprises:
receiving a request for discovering a target terminal device having functionality required for interworking between the terminal device and a service.

17. The device of claim 16, wherein the request for discovering the target terminal device comprises the device profile of the terminal device.

18. The device of claim 16, wherein the plurality of operations further comprises:
extracting a suitable target device profile from candidate device profiles, based on the policy information of the terminal device.
